(19) United States
(12) Patent Application Publication
(10) Pub. No.: US 2009/0202392 A1
(43) Pub. Date: Aug. 13, 2009

(54) PIPETTE TIP

(76) Inventors: Hikaru URANO, Kanagawa-ken (JP); Takeshi Igarashi, Asaka-shi (JP); Shuichi Takahashi, Asaka-shi (JP); Fuminori Arai, Kanagawa-ken (JP)

Correspondence Address: BIRCH STEWART KOLASCH & BIRCH, PO BOX 747, FALLS CHURCH, VA, 22040-0747, US

(21) Appl. No.: 12/366,683

(22) Filed: Feb. 6, 2009

(30) Foreign Application Priority Data
Feb. 8, 2008 (JP) 029306/2008
Dec. 25, 2008 (JP) 330007/2008

(51) Int. Cl. B01L 3/02

(52) U.S. Cl. 422/100

(57) ABSTRACT

A pipette tip formed by a polypropylene substrate coated with a water repellent agent. The water repellent agent contains a silicone resin containing at least one specific substance selected from the group consisting of diisononyl phthalate, diisodecyl phthalate, trioctyl trimellitate and poly (1,3-butanediol adipate). The total mass of the specific substance is 1-30 mass % of the silicone resin.

### BACKGROUND OF THE INVENTION

1. Field of the Invention

The present invention relates to a pipette tip that is fitted on an end of a suction nozzle for intaking and holding a liquid therein and for dispensing a predetermined amount liquid.

2. Description of the Related Art

A biochemical analysis apparatus is used, for example, to measure a liquid sample, such as blood or urine. The liquid sample to be measured is placed in the form of a predetermined amount of droplet on a biochemical analysis element, or a small amount of the liquid sample is supplied into a dilution vessel and is diluted at a predetermined ratio by a diluting liquid supplied thereto, and then is placed in the form of a droplet on a biochemical analysis element. To intake the liquid sample, the diluting liquid, or the mixture of the liquid sample and the diluting liquid from a container and dispense it, a suction nozzle is provided, and a pipette tip is removably fitted on the end of the suction nozzle, so that the liquid is taken into the pipette tip from the container and then is dispensed onto the biochemical analysis element or into the dilution vessel.

The pipette tip is made of plastic and is disposable. Unlike a pipette which directly intakes the liquid into the suction nozzle thereof, this type of pipette tip does not require washing and thus improves operational efficiency. This type of pipette tip is commonly used, and is disclosed, for example, in U.S. Pat. Nos. 3,855,867 and 4,347,875.

Examples of the plastic used for forming the pipette tip include highly water repellent materials, such as polypropylene, polystyrene and polyethylene. These plastic materials exhibit sufficient water repellency for a common aqueous solution, such as pure water or normal saline solution, and therefore there is no problem in intaking or dispensing such liquids.

However, a liquid sample such as blood (such as whole blood, blood plasma or blood serum), urine, or a diluted solution thereof contains protein, sugar, nucleic acid, or the like, and has a high viscosity of 1.5-2.5 mPa·s. Therefore, such a liquid sample tends to remain on the surface of the outer wall of the plastic pipette tip, and this may often hinder formation of a droplet of the liquid sample at the end portion of the pipette tip when the liquid sample taken in the pipette tip is to be dispensed, and may cause a so-called liquid running-up phenomenon, in which the liquid sample runs up along the outer wall of the pipette tip. As a result, the plastic pipette tip may sometimes fail to dispense the liquid sample such as blood onto a biochemical analysis element or into a dilution vessel.

In order to eliminate the liquid running-up phenomenon of the liquid sample such as blood, Japanese Unexamined Patent Publication No. 1(1989)-317548, for example, discloses a pipette tip having a plastic body with an oil coating applied to the surface thereof. Further, U.S. Pat. No. 5,336,468, for example, discloses a pipette tip having a plastic body for use with a biochemical analysis apparatus for analyzing a liquid sample such as blood, which is coated with a silicone resin having a high molar weight. Furthermore, U.S. Pat. No. 5,516,578 discloses imparting water repellency or oil repellency to a fiber substrate or other types of substrates using a composition containing a fluoroaliphatic group-containing substance and a cyclic carboxylic acid anhydride-containing polymer.

However, although the oil coating disclosed in Japanese Unexamined Patent Publication No. 1(1989)-317548 eliminates the liquid running-up phenomenon, the coated oil may dissolve in the analyte and affect the measurement result of the biochemical analysis, or may easily be removed and fail to provide a practical level of durability. The silicone resin coating disclosed in U.S. Pat. No. 5,336,468 cannot eliminate the liquid running-up phenomenon when the pipette tip is used with a biochemical analysis apparatus having a higher operation speed than conventional biochemical analysis apparatuses.

The body of the pipette tip is typically made of a plastic material, and in particular, a polypropylene substrate has high general versatility. However, applying the coating of a silicone resin containing a fluoroaliphatic group disclosed in U.S. Pat. No. 5,516,578 to the pipette tip made of a plastic material, the coating is easily removed and thus fails to provide a practical level of durability.

### SUMMARY OF THE INVENTION

In view of the above-described circumstances, the present invention is directed to providing a pipette tip that is free of the liquid running-up phenomenon and can reliably dispense a liquid sample onto a biochemical analysis element or into a dilution vessel.

The pipette tip of the invention is formed by a polypropylene substrate coated with a water repellent agent, the water repellent agent containing a silicone resin containing at least one specific substance selected from the group consisting of diisononyl phthalate, diisodecyl phthalate, trioctyl trimellitate and poly (1,3-butanediol adipate), wherein the total mass of the specific substance is 1-30 mass % of the silicone resin.

The pipette tip of the invention is used for biochemical analysis of a liquid sample such as blood or urine.

### BRIEF DESCRIPTION OF THE DRAWINGS

FIG. 1 is a front view of one aspect of a pipette tip of the present invention,

FIG. 2 shows photographic images showing how a diluted solution DL on a pipette tip of example 1 is repelled, and

FIG. 3 shows photographic images showing how the diluted solution DL on a pipette tip of comparative example is repelled.

### DESCRIPTION OF THE PREFERRED EMBODIMENTS

A pipette tip of the present invention is formed by a polypropylene substrate coated with a water repellent agent. The water repellent agent includes a silicone resin containing at least one specific substance selected from the group consisting of diisononyl phthalate, diisodecyl phthalate, trioctyl trimellitate and poly (1,3-butanediol adipate), and the total mass of the specific substance is 1-30 mass % of the silicone resin.

Examples of the silicone resin, which forms the base of the water repellent agent, include silicone resins, such as polydialkyl siloxane or polydiaryl siloxane, which are disclosed, for example, in U.S. Pat. No. 5,336,468. The concentration of the silicone resin in the coating solution may be 1-40 mass %, or optionally 2-20 mass %, of the total mass of the water repellent agent.

The specific substance to be contained in the silicone resin is at least one selected from the group consisting of diisononyl phthalate, diisodecyl phthalate, trioctyl trimellitate and poly(1,3-butanediol adipate), which may be used alone or in an appropriate combination thereof. Mean molecular weight of poly(1,3-butanediol adipate) may be in the range from 500 to 2000. Either used alone or in combination, the concentration of the specific substance (in the total mass) may be 1-30 mass %, or optionally 2-25 mass %, of the silicone resin. If the concentration of the specific substance is less than 1 mass %, tendency of the liquid running-up phenomenon is increased when the liquid sample such as blood is measured by a biochemical analysis apparatus having a higher operation speed than conventional biochemical analysis apparatuses. On the other hand, if the concentration of the specific substance exceeds 30 mass %, the silicone resin and the specific substance may separate from each other when the liquid sample such as blood is measured by a biochemical analysis apparatus, and the specific substance may affect the measurement value.

A solvent used for preparing the water repellent agent is not particularly limited as long as the silicone resin and the specific substance dissolve in the solvent, and examples thereof include n-hexane, cyclohexane, toluene, isoparaffin, kerosene, petroleum ether, ether, acetone, ethyl acetate and MEK, which may be used alone or may be mixed appropriately.

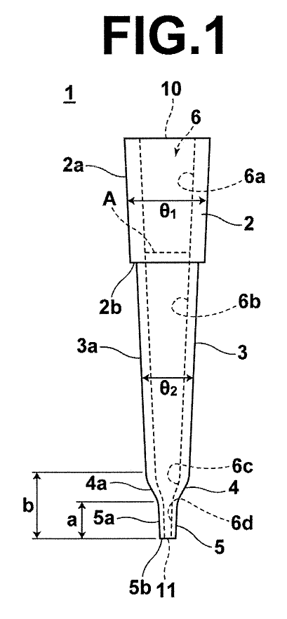

Now, the shape of the pipette tip of the invention is described with reference to FIG. 1. It should be noted that, although the structure of the pipette tip is explained with reference to the shape shown in FIG. 1, the shape of the pipette tip of the invention is not limited to one shown in FIG. 1.

The pipette tip 1 shown in FIG. 1 is formed of polypropylene in a single piece. The pipette tip 1 includes, at the upper portion thereof, a fitting portion 2 including an insertion opening 10 at the upper end thereof, a liquid holding portion 3 formed below the fitting portion 2, an inclined step portion 4 formed below the liquid holding portion 3, an end portion 5 including an intake/dispense port 11 having a small diameter provided at the end thereof, and an internal hole 6 running through the pipette tip 1 from the insertion opening 10 of the fitting portion 2 to the intake/dispense port 11 of the end portion 5.

The fitting portion 2 is fitted on an end of a suction nozzle (not shown). A fitting inner surface 6a of the internal hole 6 is tapered such that the diameter of the hole gradually decreases toward a liquid holding inner surface 6b of the liquid holding portion 3, and the thickness of this portion is greater than the thickness of other portions. An outer surface 2a of the fitting portion 2 is also tapered. The outer surface 2a and the fitting inner surface 6a are tapered at the same taper angle θ1 so that this portion has a uniform thickness. The outer surface 2a may have a uniform diameter, and in this case, only the fitting inner surface 6a is tapered. The taper angle θ1 of the outer surface 2a may be 0° (when the diameter is uniform) to about 10°, and the taper angle θ1 of the fitting inner surface 6a may be about 4° to about 10°. Further, the inner diameter of the insertion opening 10 at the upper end may be about 4.0 mm to about 6.0 mm, and the outer diameter of the insertion opening 10 may be about 6.0 mm to about 9.0 mm.

The lower end of the fitting portion 2 has an end face 2b forming a step and is joined to the liquid holding portion 3. The thickness of the liquid holding portion 3 is smaller than the thickness of the fitting portion 2 by the extent of the end face 2b. The outer diameter of the end face 2b may be about 5.0 mm to about 8.0 mm, and the inner diameter of the end face 2b (the inner diameter at the upper end of the liquid holding portion 3) may be about 4.0 mm to about 7.0 mm.

The liquid holding portion 3 holds the liquid taken therein. The liquid holding inner surface 6b of the internal hole 6 is tapered such that the diameter of the internal hole 6 gradually decreases toward the lower end. An outer surface 3a is also tapered. The outer surface 3a and the liquid holding inner surface 6b are tapered at the same taper angle θ2 so that this portion has a uniform thickness. However, the diameter at this portion may be uniform. The taper angle θ2 may be ° (when the diameter is uniform) to about 10°, which is smaller than the taper angle θ1 of the fitting portion 2.

A joint between the fitting inner surface 6a and the liquid holding inner surface 6b of the internal hole 6, i.e., an angle change point A, is formed at a position slightly shifted from the position of the end face 2b toward the fitting portion 2. The inner diameter at the angle change point A may be about 3.0 mm to about 5.0 mm.

The inclined step portion 4, where the diameters of the outer surface 3a and the inner surface 6c decrease at a greater rate than other portions, is formed at the lower end of the liquid holding portion 3. The outer surface 4a and the inner surface 6c of the inclined step portion 4 are smoothly joined to the portions above and below the inclined step portion 4 via curved surfaces. The end portion 5 extending downward from the lower end of the inclined step portion 4 is tapered such that the diameters of the inner surface 6d and the outer surface 5a gradually decrease toward an end 5b.

The inner diameter of the intake/dispense port 11, which opens at the end 5b of the end portion 5, may be about 0.4 mm to about 0.8 mm, and the outer diameter thereof may be about 1.0 mm to about 1.5 mm. Further, the inner diameter at a joint between the upper end of the end portion 5 and the inclined step portion 4 (at the upper position of “a” shown in FIG. 1) may be about 0.4 mm to about 1.3 mm, and the outer diameter at the joint may be about 1.0 mm to about 2.0 mm.

The length of the end portion 5 shown by “a” in FIG. 1, i.e., the length from the end 5b to the lower end of the inclined step portion 4 may be about 2.0 mm to about 5.0 mm. To intake the liquid into the pipette tip, only the end portion 5 is dipped in the liquid. The length of the end portion 5 is determined such that the end portion 5 substantially does not bend during a forming process, and may specifically be about 2.0 mm to about 5.0 mm, or optionally be about 2.0 mm to about 4.0 mm. As the liquid is taken into the pipette tip, the liquid level is lowered. Therefore, the suction nozzle is moved down along with the lowering of the liquid level to keep the state in which only the end portion 5 of the pipette tip 1 is dipped in the liquid to continue the intaking operation.

Further, the length between the end 5b and the upper end of the inclined step portion 4 shown by “b” in FIG. 1 may be about 4.0 mm to about 10.0 mm, the length between the end 5b and the end face 2b of the fitting portion 2 may be about 15 mm to about 40 mm, the length between the end 5b and the angle change point A may be about 15 mm to about 40 mm, and the entire length between the end 5b and the upper end of the fitting portion 2 may be about 20 mm to about 50 mm.

The capacity of the liquid holding portion 3, the inclined step portion 4 and the end portion 5 for holding the liquid therein may be in the range of 100-150 μl, in view of providing accuracy of placement of a small amount of droplet of about 4-12 μl and holding a diluting liquid of about 50-100 μl therein.

The outer surface of the pipette tip of the invention is partially subjected to a water repellent treatment (at least the outer surface of the end portion 5, or optionally the outer surfaces 3a-5a of the liquid holding portion 3 and the liquid holding inner surfaces 6b-6d, may be subjected to the water repellent treatment).

In order to apply the water repellent treatment to the pipette tip of the invention, the pipette tip may be immersed in a water repellent agent to coat the pipette tip with the agent or the water repellent agent may be spray-coated on the pipette tip. In particular, a silicone resin, which is the base of the water repellent agent, and an ester plasticizer may be dissolved in a solvent, and the thus prepared water repellent agent may be coated on the pipette tip and dried.

When the pipette tip is immersed in and coated with the water repellent agent, the water repellent agent may enter the interior of the pipette tip and may clog the intake/dispense port 11 of the pipette tip. In order to prevent this, air may be blown into the pipette tip through the insertion opening 10 during or after the immersion. Further, after the immersion, the water repellent agent remaining at the end portion 5 of the pipette tip may be removed with wiping paper or wiping cloth.

The solvent used in the water repellent agent is usually removed through thermal drying. The drying temperature depends on the type of the solvent used, however, may be 50-110° C., or optionally 70-90° C., for a mixed solvent of, for example, n-hexane and isoparaffin.

Now, the pipette tip of the invention is described in further detail by means of examples.

### EXAMPLES

### Example 1

15 g of silicone resin (Shin-Etsu Chemical Co., Ltd.), 35 g of isoparaffin (Shin-Etsu Chemical Co., Ltd.), 250 g of n-hexane (Wako Pure Chemical Industries, Ltd.), and 2 g of diisononyl phthalate DINP (Wako Pure Chemical Industries, Ltd.) were mixed to prepare a water repellent agent. The pipette tip made of polypropylene shown in FIG. 1 was subjected to a water repellent treatment by immersing the pipette tip in the water repellent agent while blowing air into the pipette tip through the insertion opening 10. The water repellent agent remaining at end portion 5 of the pipette tip was removed with wiping paper and the pipette tip was dried at 72-80° C. for about one minute.

### Example 2

The pipette tip was coated in the same manner as example 1 except that the amount of diisononyl phthalate DINP was changed to 3 g.

### Example 3

2.7 g of silicone resin (Shin-Etsu Chemical Co., Ltd.), 6.3 g of isoparaffin (Shin-Etsu Chemical Co., Ltd.), 21 g of n-hexane (Wako Pure Chemical Industries, Ltd.), and 0.6 g of trioctyl trimellitate TOTM (Wako Pure Chemical Industries, Ltd.) were mixed to prepare a water repellent agent, and the pipette tip was coated with the water repellent agent in the same manner as example 1.

### Example 4

0.3 g of diisononyl phthalate DINP (Wako Pure Chemical Industries, Ltd.) and 0.3 g of diisodecyl phthalate DIDP (Wako Pure Chemical Industries, Ltd.) was used in place of 0.6 g of trioctyl trimellitate TOTM (Wako Pure Chemical Industries, Ltd.) of example 3 to prepare a water repellent agent, and the pipette tip was coated with the water repellent agent in the same manner as example 1.

### Example 5

0.5 g of poly(1,3-butanediol adipate) BAA-15 (Daihachi Chemical Industry Co., Ltd.) was used in place of 2 g of diisononyl phthalate DINP (Wako Pure Chemical Industries, Ltd.) of example 1 to prepare a water repellent agent, and the pipette tip was coated with the water repellent agent in the same manner as example 1.

### Comparative Example

A water repellent agent was prepared in the same manner as example 1 except that diisononyl phthalate DINP (Wako Pure Chemical Industries, Ltd.) was not used, and the pipette tip was coated with the water repellent agent in the same manner as example 1.

### Evaluation

Ten pipette tips were produced for each of examples 1-5 and the comparative example, and were used in combination with a biochemical analysis apparatus, FUJI DRY-CHEM 7000 (manufactured by Fuji film Corporation) for diluting a blood sample and placing a droplet of the blood sample on an analysis slide. Then, the number of the pipette tips among the ten pipette tips of each example which had the liquid running-up phenomenon was counted through observation. The pipette tips of each example were evaluated as “good” if none of them had the liquid running-up phenomenon, or evaluated as “poor” if at least one of them had the liquid running-up phenomenon.

Further, a water-soluble dye was added to a FUJI DRY-CHEM diluted solution DL CRP (having an absorbance at the wavelength of 280 nm of about 0.4 in a protein solution, and hereinafter referred to as “DL”). The pipette tips of examples 1-5 and the comparative example were dipped in this DL from the side of the intake/dispense port 11 up to the inclined step portion 4, and then the pipette tip was pulled out from the DL to measure a time taken for the DL to be repelled from the end portion 5 of each pipette tip.

Formulations of the water repellent agents of examples 1-5 and the comparative example and results of the evaluation are shown in Table 1 below.

TABLE 1

| Water repellent agent | | Ex. 1 | Ex. 2 | Ex. 3 | Ex. 4 | Ex. 5 | Comp. Ex. |
|---|---|---|---|---|---|---|---|
| | silicone resin | 15 | 15 | 2.7 | 2.7 | 15 | 15 |
| Specific | diisononyl phthalate DINP | 2 | 3 | — | — | — | — |
| substance | trioctyl trimellitate TOTM | — | — | 0.6 | 0.3 | — | — |
| | diisodecyl phthalate DIDP | — | — | — | 0.3 | — | — |
| | poly(1,3-butanediol adipate) | | | | — | 0.5 | |
| | BAA-15 | | | | | | |
| Solvent | isoparaffin | 35 | 35 | 6.3 | 6.3 | 35 | 35 |
| | n-hexane | 250 | 250 | 21 | 21 | 250 | 250 |
| Ratio of specific substance to silicone resin | | 13 | 20 | 22 | 22 | 3 | — |
| (mass %) | | | | | | | |
| Evaluation | liquid running-up phenomenon | Good | Good | Good | Good | Good | Poor |
| | repelling time (second) | 0.2 | 0.2 | 0.2 | 0.2 | 0.2 | 2 |

As can be seen from Table 1, none of the pipette tips of examples 1-5 had the liquid running-up phenomenon, whereas two of the ten pipette tips of the comparative example had the liquid running-up phenomenon. The repelling time taken for repelling the DL from the end portion 5 of the pipette tips of the comparative example was two seconds, whereas the repelling time was 0.2 seconds for the pipette tips of examples 1-5, which is shorter by an order of magnitude.

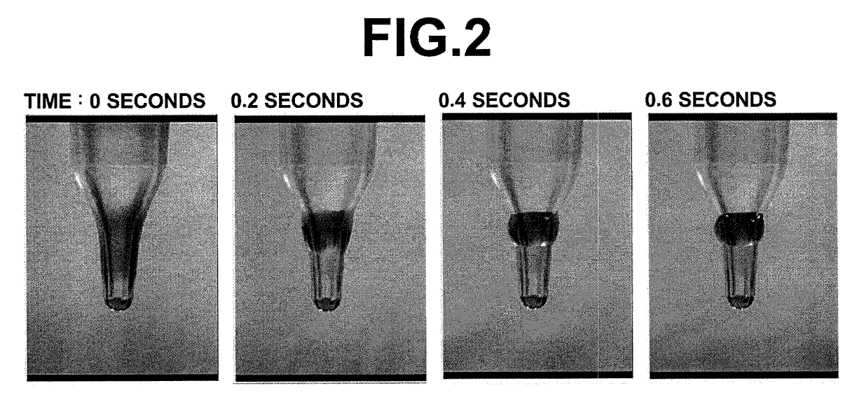

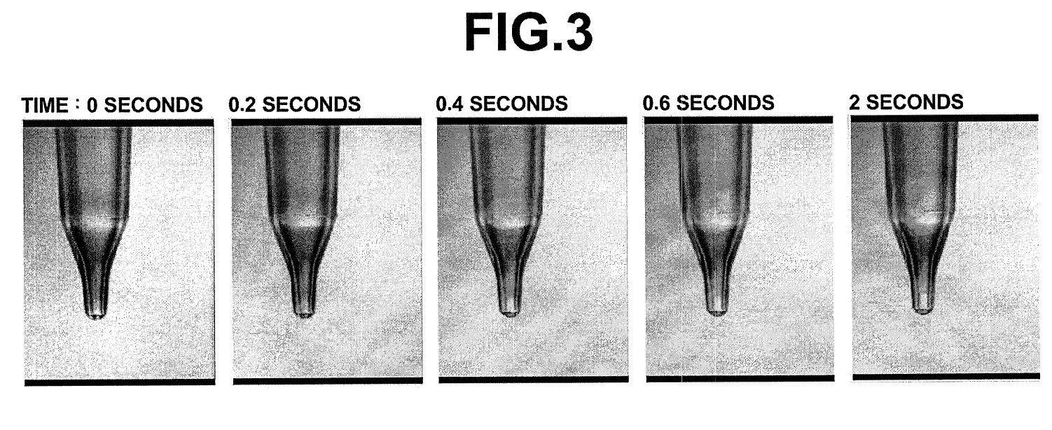

FIGS. 2 and 3 shows videographed images showing how the diluted solution DL is repelled for the pipette tip of example 1 and the pipette tip of the comparative example. With respect to the pipette tip of example 1, no DL remained on the inner surface 6d of the internal hole 6 after 0.2 seconds, and the sample remaining on the pipette tip was repelled to and held at the upper position of the outer surface 5a, where the remaining liquid does not hinder placement of a droplet of the sample. In contrast, with respect to the pipette tip of the comparative example, the sample remained on the inner surface 6d of the internal hole 6 and over a wide area of the outer surface 5a even after two seconds.

As can be seen from the above-described results, the pipette tip of the invention can minimize the liquid running-up phenomenon of the liquid sample such as blood, and has a shorter water repelling time. Therefore, even when the pipette tip is used for measurement with a biochemical analysis apparatus having a higher operation speed than conventional biochemical analysis apparatuses, the liquid sample can accurately be dispensed onto a biochemical analysis element or into a dilution vessel.

The pipette tip of the invention is formed by a polypropylene substrate coated with a water repellent agent. The water repellent agent is a silicone resin containing at least one specific substance selected from the group consisting of diisononyl phthalate, diisodecyl phthalate, trioctyl trimellitate and poly(1,3-butanediol adipate), and the total mass of the specific substance is 1-30 mass % of the silicone resin. The pipette tip of the invention can effectively minimize the liquid running-up phenomenon since the surface of the outer wall of the pipette tip is provided with water repellency to repel the liquid sample, and thus can reliably dispense the liquid sample onto a biochemical analysis element or into a dilution vessel.

In particular, the pipette tip of the invention can provide accurate measurement of the liquid sample such as blood even when the pipette tip is used for measurement with a biochemical analysis apparatus having a higher operation speed than conventional biochemical analysis apparatuses.

What is claimed is:

1. A pipette tip comprising a polypropylene substrate coated with a water repellent agent, the water repellent agent comprising a silicone resin containing at least one specific substance selected from the group consisting of diisononyl phthalate, diisodecyl phthalate, trioctyl trimellitate and poly (1,3-butanediol adipate), wherein the total mass of the specific substance is 1-30 mass % of the silicone resin.

2. A pipette tip as claimed in claim 1 used for biochemical analysis of a sample such as blood or urine.
